(19) United States
(12) Patent Application Publication
(10) Pub. No.: US 2026/0204984 A1
(43) Pub. Date: Jul. 16, 2026

(54) FLUID SYSTEM FOR AN ELECTRIC DRIVE DEVICE

(71) Applicant: ZF Friedrichshafen AG, Friedrichshafen (DE)

(72) Inventors: Linus Eschenbeck, Wangen (DE); Leschek Debernitz, Eriskirch (DE); Julia Klein, Langenargen (DE); Benjamin Brose, Tettnang (DE); Claudia Risch, Salem (DE); Maxim Pereverzev, Ravensburg (DE)

(73) Assignee: ZF Friedrichshafen AG, Friedrichshafen (DE)

(21) Appl. No.: 19/136,734

(22) PCT Filed: Dec. 6, 2023
(86) PCT No.: PCT/EP2023/084408

§ 371 Date: Jun. 6, 2025

(30) Foreign Application Priority Data
Dec. 20, 2022 (DE) 10 2022 213 963.1

(51) Int. Cl. H02K 9/19; B60K 11/04; H02K 5/20; H02K 11/33

(52) U.S. Cl. CPC H02K 9/19; B60K 11/04; H02K 5/203; H02K 11/33

(57) ABSTRACT

A fluid system for an electric drive device having power electronics for controlling an electric drive machine comprises a housing shell for accommodating the power electronics, a cooling element having a first side for supporting the power electronics and a second side for a cooling fluid to wash around, and a heat exchanger for transferring heat between a lubricating fluid of the drive device and the cooling fluid. Fluid channels are provided here in order to conduct the cooling fluid from an inlet to the second side, from there to the heat exchanger and from the heat exchanger to an outlet.

### CROSS-REFERENCE TO RELATED APPLICATIONS

This application is a U.S. national stage application under 35 U.S.C. § 371 of PCT Application No. PCT/EP2023/084408, filed on Dec. 6, 2023, and published as WO 2024/132518 A1 on Jun. 27, 2024, which claims priority from German Application No. DE 10 2022 213 963.1, filed on Dec. 20, 2022, the entirety of which are each hereby fully incorporated by reference herein.

### FIELD

The present disclosure relates to a fluid system for an electric drive. In particular, the present disclosure relates to a fluid system for cooling a drive with a coolant flowing through it.

### BACKGROUND

An electric drive comprises an electric motor for a motor vehicle. The drive comprises power electronics for converting direct current from an electrochemical battery into alternating currents for the motor. The power electronics heat up during this conversion and must be cooled.

A coolant circuit that preferably uses an aqueous solution for the coolant can remove this heat. The drive can contain mechanical components such as a transmission or clutch that are lubricated and cooled with an oil circuit. The heat from the oil circuit can be transferred by a heat exchanger to the aqueous circuit.

The heat exchanger and power electronics are normally separate from the electric drive. When assembling the drive, it must be ensured that all of the fluid connections allow for fluid to pass through them and are sealed against the exterior. This may require more tubes or hoses for connecting and checking hydraulic connections.

DE 10 2019 124 280 A1 proposes placing the heat exchanger directly on the drive and covering it with a housing, which is open on one side and contains the power electronics. Consequently, at least the part of the heat exchanger through which oil flows can be connected before attaching the power electronics.

### SUMMARY

Assembly of the drive may still be difficult or problematic. Production of the elements that contain fluid channels may be difficult and expensive. One object of the present disclosure is to create a better fluid system for an electric drive. The present disclosure solves this problem with the subject matter disclosed herein, which also describes preferred embodiments.

In a first aspect of the present disclosure, the fluid system for an electric drive that has power electronics for an electric motor comprises a shell for the power electronics, a cooling element with a first side that bears on the power electronics and a second side over which a coolant flows, and a heat exchanger for transferring heat between a lubricant for the drive and the coolant. There are fluid channels for conducting the coolant from an intake to the second side, from there to the heat exchanger, and from there to an outlet.

The shell can be part of a housing for the power electronics. The shell preferably forms a basin or base plate that can be closed with a cover or another shell. The heat exchanger can be a standard component. A plate heat exchanger is normally used, of which there are numerous types, which can be cylindrical or rectangular. A first flow of coolant and a second flow of oil can flow through the heat exchanger, and heat can be exchanged between the fluids without mixing them. The heat exchanger can be connected to an oil circuit for the drive, such that the second flow is part of the oil circuit.

The coolant can flow such that it first absorbs heat from the power electronics, thus heating it slightly, before absorbing heat from the oil circuit. This keeps the power electronics cooler than the oil circuit.

The heat exchanger is preferably attached to the fluid system such that a separate unit is formed. Hydraulic connections to the fluid system can be obtained and checked before the fluid system is incorporated in the drive. The fluid system is preferably designed such that it can be replaced on the drive. Fluid connections from the heat exchanger to the oil circuit can be created automatically or with little additional effort. The connections can be inside or outside a bearing surface between the fluid system and the drive. If a connection is inside, oil escaping it can be collected more easily. If it is outside, the seal on the connection is easier to produce and check.

The intake and outlet for the coolant can be formed on the fluid system such that these connections can be easily accessed after attaching it to the drive. The fluid system can be sealed between the intake and outlet for the coolant both prior to and after it is installed on the drive. Another mechanical or electrical connection can also be obtained during or after attaching the fluid system to the drive. The fluid system can be attached and checked separately more effectively, prior to placing it on the drive as a finished component.

Two versions of the fluid system are proposed.

The fluid channels in the first version are formed in the shell. This shell is formed in particular in a casting or injection molding process, and the fluid channels can be easily and inexpensively produced. The intake and outlet for the coolant can be formed on ends of the fluid channels. Hydraulic connectors for the intake and outlet can also be formed on the shell. The heat exchanger in this embodiment can be placed and sealed on the shell, prior to attaching the fluid system to the drive.

The cooling element in this version can comprise a separate component from the shell, which is attached thereto such that it abuts one of the fluid channels. In particular, this fluid channel can border on the second side of the cooling element. This results in good physical contact between the coolant and the second side. The coolant preferably flows along the second side. Accordingly, the second side borders on a side of the fluid channel. It is easier to work on the shell near the fluid channel prior to attaching the cooling element thereto.

The cooling element can be made of a different material than that of the shell. By way of example, the shell can be made of a light metal, and the cooling element can be made of a material such as copper that is more thermally conductive. Heat exchange between the power electronics and the coolant is thus improved. Moreover, the shape of the cooling element can be independent of that of the shell. Both elements can be produced with different methods.

The cooling element in a second version can be formed as an integral part of the housing, and/or from the same material. In this case, the fluid system has an adapter between the shell and the heat exchanger in which the fluid channels are formed. The adapter can be easily produced in a casting or injection molding process, in order to correctly form the fluid channels. The heat exchanger can be attached and sealed to the adapter prior to or after the adapter is attached and sealed to the shell. Because of the better design possibilities, the adapter can already comprise an end plate or base plate for the heat exchanger. Consequently, the heat exchanger can be smaller or lighter.

It is also preferred in this version that the shell is attached to the adapter near the cooling element such that shell borders on a fluid channel in the adapter. Coolant can thus flow over the cooling element more effectively, in order to remove heat from the power electronics.

Preferred embodiments of the cooling element are proposed for each version. In one embodiment, the cooling element is substantially flat. The sides of the cooling element can be opposite one another. A thermal resistance of the cooling element can thus remain substantially constant over its surfaces. A thinner cooling element has a lower thermal resistance between the two sides.

The second side also preferably has a raised or recessed structure to increase the surface area over which the coolant flows. The structure can be three dimensional. Heat exchange between the cooling element and the coolant can be improved in this way. The peak temperature of the power electronics can be lowered.

The structure can comprise numerous protrusions, between which the coolant can flow. The protrusions are preferably perpendicular to the direction in which the coolant flows. The coolant also preferably flows along the second side. The protrusions are then substantially perpendicular to the second side. The protrusions can all be identical and of the same length. The ends of the protrusions on the second side can bear on a flat surface. This ensures that the coolant flows over the available surface area on the second side in an optimal manner.

The protrusions can be pins. The cross section of the protrusions can be round, oval, or polygonal. The pins can be arranged in a uniform pattern of rows and columns, for example. The successive rows can be laterally offset in the flow direction, such that the coolant can meander between the protrusions. In some embodiments, the protrusions can be referred to as pin fins.

Another aspect of the present disclosure relates to a drive that contains the fluid system described herein.

Another aspect of the present disclosure relates to a motor vehicle that contains the drive described herein.

Another aspect of the present disclosure relates to a method for creating the fluid system described herein, and attaching the heat exchanger to the fluid system, prior to attaching the fluid system to the drive.

The heat exchanger can be attached to the shell in the first version, and to the adapter in the second version. After attaching the heat exchanger, the seals for the hydraulic connection can be checked. The section between the intake and outlet can be filled with a liquid for this and then pressurized. If no fluid escapes, the seal test can be regarded as successful. If the cooling element is a separate component, it can be attached and sealed to the fluid system prior to testing the seal.

The present disclosure shall be described below in greater detail in reference to the drawings.

### BRIEF DESCRIPTION OF THE DRAWINGS

FIG. 1 shows a fluid system in an electric drive;

FIG. 2 shows a first version of the fluid system;

FIG. 3 shows a cut through the first version of the fluid system;

FIG. 4 shows part of the first version of the fluid system;

FIG. 5 shows a second version of the fluid system;

FIG. 6 shows a cut through the second version of the fluid system; and

FIG. 7 shows part of the second version of the fluid system.

### DETAILED DESCRIPTION

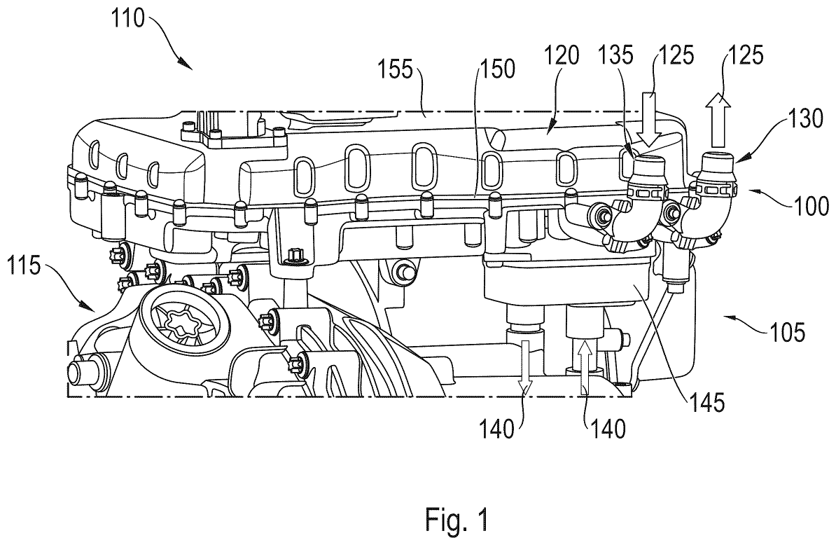

FIG. 1 shows a fluid system 100 on an electric drive 105. The drive 15 is for a motor vehicle 110, in particular a passenger automobile or a truck. The drive 105 comprises an electric motor 115, e.g. a permanent magnet synchronous motor (PSM). Power electronics 120, which can contain a converter, provide the appropriate electricity for the motor 115. The power electronics 120 normally contains current control valves in the form of semiconductors, which can heat up when in use due to electrical currents or switching losses.

A coolant 125 circulating in the cooling circuit can be introduced into the fluid system 100 through an intake 130, heated therein, and exit through an outlet 135. After cooling the coolant 125, it can be sent back to the intake 130.

The fluid system 100 is designed to first absorb heat from the power electronics 120 in the coolant 125, and then exchange heat with a lubricant 140. There is a heat exchanger 145 for transferring heat between the coolant 125 and the lubricant 140, which can preferably be attached to the fluid system 100 before the fluid system 100 is attached to the drive 105.

The fluid system 100 in this embodiment is housed in a shell 150 that is designed to bear on, or be attached to, the drive 105. There is also a cover 155 for the shell 150 to form a housing. The power electronics 120 are contained in the housing.

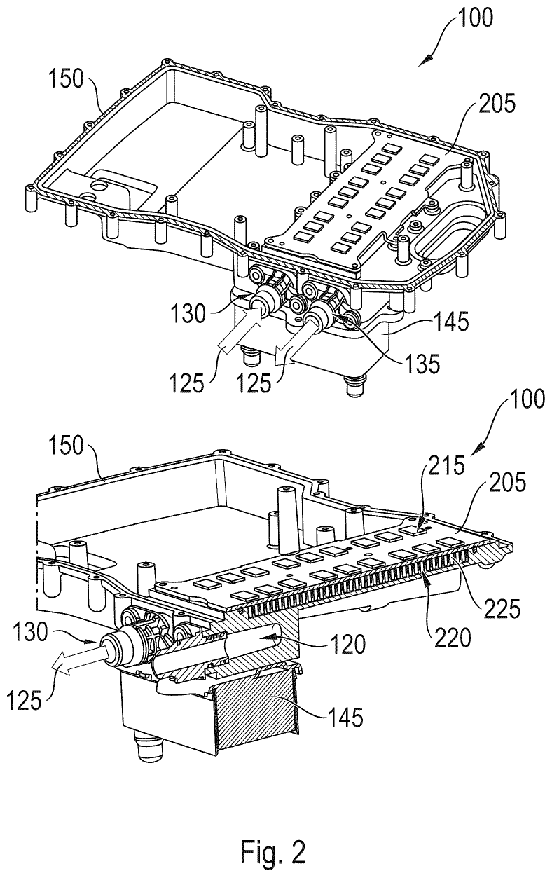

FIG. 2 shows a first version of the fluid system 100. The shell 150, heat exchanger 145, connections for the intake 130 and outlet 135, and a cooling element 205 are shown from two different perspectives. The shell 150 is preferably cast and contains one or more fluid channels 210. The fluid channels 210 conduct the coolant 125 from the intake 130 along the cooling element 205, to the heat exchanger 145, and from there to the outlet 135. This may require three separate fluid channels 210.

One of the fluid channels 210 can be delimited at the bottom by the shell 150 and at the top by the cooling element 205. The cooling element 205 is substantially flat and has a first side 215 and a second side 220, which lie opposite one another. The first side 215, which faces upward in FIG. 2, bears on the power electronics 120. A raised structure can be formed on the first side 215 that improves the physical contact to the warmer parts of the power electronics 120 when in use.

The cooling element 205 preferably has a raised structure on the second side 220, which can be formed by protrusions 225 in particular, which can be referred to as a pin fin structure. The protrusions 225 are preferably parallel and extend away from the first side 215, and each have the same cross section. The protrusions 225 normally all have the same length. Ends of the protrusions 225 may bear on a bearing surface on the shell 150. The protrusions 225 may be arranged in a uniform pattern such that they lie more effectively in the flow of the coolant 125.

The cooling element 205 is preferably separate from the shell 150, and connected and sealed thereto. A highly thermally conductive material such as copper can be used for the production of the cooling element 205. The shell 150 is normally made of another material such as a light metal.

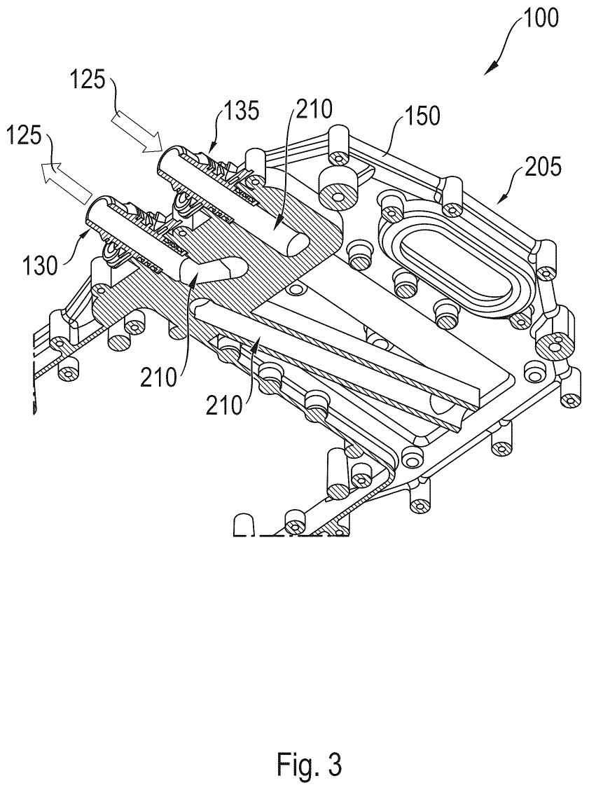

FIG. 3 shows a cut through a first version of the fluid system 100. The shell 150 has been cut horizontally. This exposes a first fluid channel 210 that leads from the intake 130 to the cooling element 205 (not shown), a second channel 210 that leads from the cooling element 205 to an intake on the heat exchanger 145 (not shown), and a third fluid channel 210 that leads from the outlet on the heat exchanger 145 to the outlet 135 for the fluid system 100.

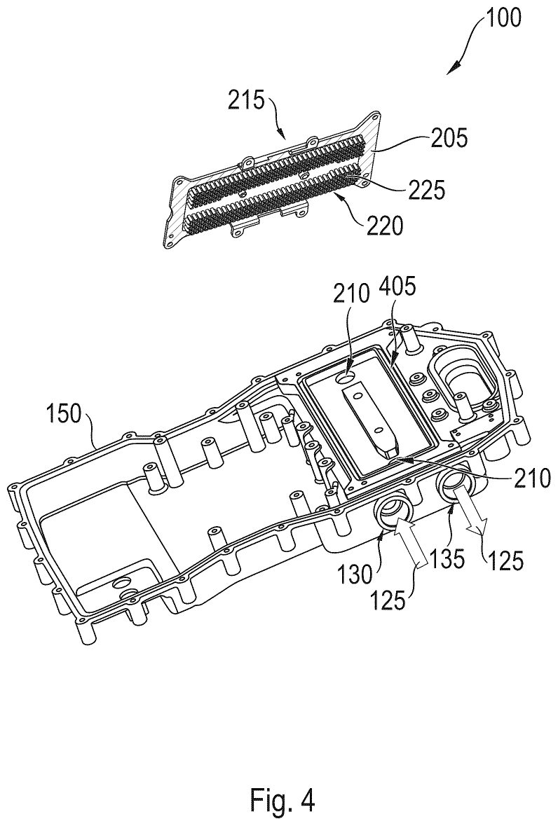

FIG. 4 shows a cooling element 205 and a shell 150 for a first version of the fluid system 100. A circumferential groove 405 is formed in a section of the shell 150 that the cooling element can bear on, with which the cooling element 205 is sealed off from the shell 150. One end of the first fluid channel 210 can be seen facing the viewer through which coolant 125 can be conducted to the cooling element 205. An end of the second fluid channel 210 can be seen facing away from the viewer through which the coolant 125 is subsequently conducted toward the heat exchanger 145.

The second side 220 of the cooling element 205 faces the viewer. This clearly has two rows of protrusions 225 in the form of pins. The space between the two rows can be filled by a structure element on the shell 150 after the cooling element 205 is attached thereto.

It should be noted that the cooling element 205 is not shown in the right position for attaching it to the shell 150. Moreover, the cooling element 205 can have another design than that intended for the shell 150.

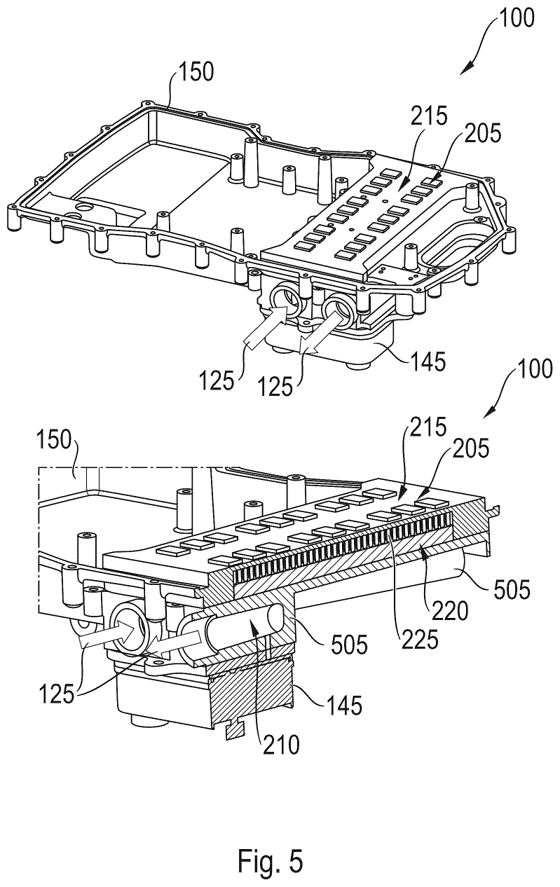

FIG. 5 shows a second version of the fluid system 100. There is an adapter 505 between the shell 150 and the heat exchanger 145 in this version, in which the fluid channels 210 are formed. The cooling element is formed as an integral part of the shell, and from the same material. The first side 215 and/or second side 220 of the cooling element 205 can substantially be the same as the cooling element 205 in the first version.

The adapter 505 is mechanically connected to both the shell 150 and the heat exchanger 145, and sealed with respect to the coolant 125. The adapter 505 can be made from a similar or the same material as the shell 150. When the fluid channels 210 are formed in the adapter, it is easier to produce the shell 150.

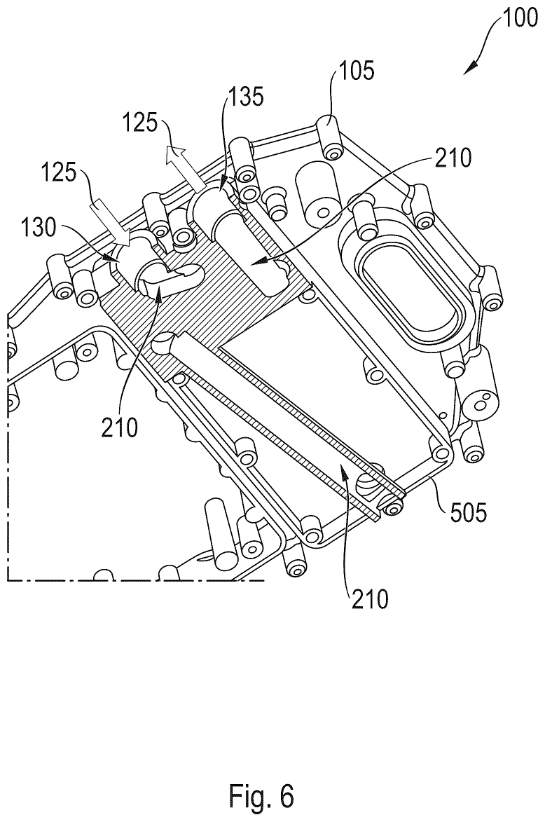

FIG. 6 shows a cut through the second version of the fluid system 100. The cutting plane passes through the adapter 505 attached to the shell 150. There are three fluid channels 210, which lead in the same manner as those in the first version shown in FIG. 3 from the intake 130 to the cooling element 205 (not shown), from the cooling element 205 to an intake on the heat exchanger 145 (not shown), and from an outlet on the heat exchanger 145 to the outlet 135 for the fluid system 100. These fluid channels 210 are substantially within the adapter 505 and not formed on the shell 150. At part of a fluid channel 210 could be formed between the adapter 505 and the shell 150, however.

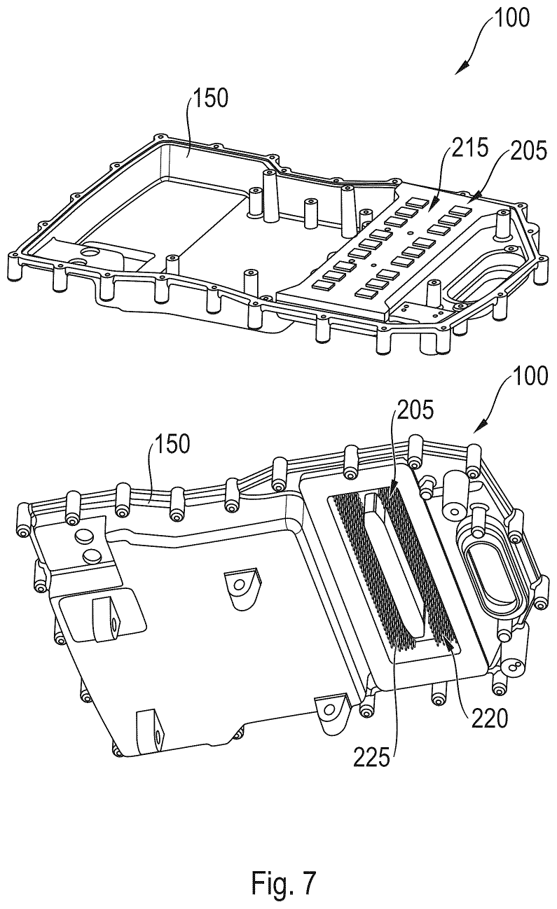

FIG. 7 shows a second version of a shell 150 for the fluid system 100. This shows how the cooling element 205 is formed as an integral part of the outside of the shell 150. The first side 215 is designed to bear on the power electronics 120, and the second side 220 is designed for coolant 125 to flow over it.

It should be noted that individual elements or embodiments shown herein do not necessarily belong to the same versions.

### REFERENCE SYMBOLS

100 fluid system
105 drive
110 motor vehicle
115 motor
120 power electronics
125 coolant
130 intake
135 outlet
140 lubricant
145 heat exchanger
150 shell
155 cover
205 cooling element
210 fluid channel
215 first side
220 second side
225 protrusion
405 groove
505 adapter

1. A fluid system for an electric drive that has power electronics for controlling an electric motor, the fluid system comprising:
a shell for the power electronics;
a cooling element with a first side that bears on the power electronics and a second side over which coolant flows;
a heat exchanger configured to transfer heat between a lubricant for the electric drive and the coolant; and
fluid channels configured to conduct the coolant from an intake on the second side to the heat exchanger and from the heat exchanger to an outlet.

2. The fluid system according to claim 1,
wherein the heat exchanger is attached to the fluid system such that a separate unit is formed.

3. The fluid system according to claim 1,
wherein the fluid channels are formed in the shell.

4. The fluid system according to claim 3,
wherein the cooling element comprises a separate component that is attached to the shell such that the separate component delimits a fluid channel of the fluid channels in a fluid-tight manner.

5. The fluid system according to claim 4,
wherein the cooling element is made of a different material than the shell

6. The fluid system according to claim 1,
wherein the cooling element is formed as an integral part of the shell, and
wherein the fluid system comprises:
an adapter between the shell and the heat exchanger, in which the fluid channels are formed.

7. The fluid system according to claim 6,
wherein the shell is attached to the adapter near the cooling element such that the shell delimits a fluid channel in the adapter in a fluid-tight manner.

8. The fluid system according to claim 1,
wherein the first side and the second side of the cooling element are opposite one another.

9. The fluid system according to claim 1,
wherein the second side has a predefined raised structure to enlarge a surface area over which the coolant flows.

10. The fluid system according to claim 9,
wherein the predefined raised structure comprises a plurality of parallel protrusions between which the coolant can flow.

11. The fluid system according to claim 10,
wherein the plurality of parallel protrusions are formed by pins.

12. An electric drive comprising:
the fluid system according to claim 1.

13. A motor vehicle comprising:
the electric drive according to claim 12.

14. A method of producing the fluid system according to claim 1, comprising:
attaching the heat exchanger to the fluid system before the fluid system is attached to the electric drive.
